(19) United States
(12) Patent Application Publication
(10) Pub. No.: US 2007/0205999 A1
(43) Pub. Date: Sep. 6, 2007

(54) Image display apparatus

(75) Inventors: Hajime Akimoto, Kokubuji (JP); Mitsuhide Miyamoto, Kokubunji (JP)

Correspondence Address: MILES & STOCKBRIDGE PC, 1751 PINNACLE DRIVE, SUITE 500, MCLEAN, VA, 22102-3833, US

(73) Assignee: Hitachi Displays, Ltd.

(21) Appl. No.: 11/657,483

(22) Filed: Jan. 25, 2007

(30) Foreign Application Priority Data
Mar. 6, 2006 (JP) 2006-059000

(51) Int. Cl. G09G 5/00

(52) U.S. Cl. 345/207

(57) ABSTRACT

An image display apparatus for resolving the problem that read out of high-sensitivity optical signals was impossible when there is a strong backlight effect on displays of the related art and particularly liquid crystal displays. The above problem is resolved by an image display apparatus containing an optical signal summing unit for summing the optical signals output from multiple light sensing pixels, and the optical signal reader includes a function for reading out the optical signals summed by the optical signal summing unit.

### CLAIM OF PRIORITY

The present application claims priority from Japanese application JP 2006-059000 filed on Mar. 6, 2006, the content of which is hereby incorporated by reference into this application.

### FIELD OF THE INVENTION

The present invention relates to an image display apparatus capable of inputting a high sensitivity optical signal.

### BACKGROUND OF THE INVENTION

The technology of the related art is described next while referring to FIG. 19.

The structure of the related art is described first. FIG. 19 is a circuit diagram of the liquid crystal display capable of using the optical signal input of the related art. The pixels in a display section 210 are made up of a pixel switch 202 and a liquid crystal capacitor 201. The gate of the pixel switches 202 is connected to the gate line scanning circuit 212 and the other end of the pixel switch 202 is connected to a signal output circuit 211.

An optical sensor device 203 formed from a TFT (Thin-Film-Transistor) containing upper and lower gates, is formed in the display section 210. One end of the source-drain path of the optical sensor device 203 is grounded, the lower gate is connected to a bottom gate scan circuit 214, the upper gate is connected to a top gate scan circuit 215, and the other end of the source-drain path of the optical sensor device 203 is connected to a precharge circuit 216 and an optical signal sensing circuit 213. A control circuit 217 controls the signal output circuit 211, the gate line scanning circuit 212, the optical signal sensing circuit 213, a bottom gate scan circuit 214, and a top gate scan circuit 215.

The control circuit 217 is a logic IC chip utilizing for example a gate array. The bi-directional signal line 280 between the control circuit 217 and the optical signal sensing circuit 213 supplies control signals for controlling the sensing circuit 213 from the control circuit 217, and optical detection signal outputs sent to the control circuit 217 from the sensing circuit 213. A signal line 281 is a control signal for controlling the signal output circuit 211.

The operation of the device of the related art is described next.

When a specified pixel switch 22 is selected by the gate line scanning circuit and turns on, a display signal output from the signal output circuit 211 is written into a specified liquid crystal capacitor 201 via the selected pixel switch 202. The image is in this way displayed on the display section 210. When the optical signal sent from the optical sensor device 203 selected by the bottom gate scan circuit 214 and top gate scan circuit 215 is readout on from a line pre-charged by the precharge circuit 216, the optical signal sensing circuit 213 reads out this optical signal for sensing of the write optical signal pattern input by the display section 210.

This technology of the related art allows sensing a two-dimensional optical signal pattern using the display section 210 as well as showing an image on the display section 210. This technology is disclosed in greater detail for example in JP-A No. 259346/2000.

### SUMMARY OF THE INVENTION

The above described technology of the related art has the problem that readout of high-sensitivity optical signals is impossible. The effect from backlighting is particularly intense for liquid crystal displays and in some cases the backlighting input to the optical sensor device is dozens of times stronger than the light input to the display section. The signal-to-noise ratio (S/N) in the optical signal output read out from the optical sensor element is therefore extremely small so that high-sensitivity, high-speed readout is impossible. The S/N ratio also drastically deteriorates due to effects from stray light even when this technology is used in EL (Electro-Luminescence) displays and organic EL (Organic Light Emitting Diode) displays so that reading out high-speed, high-sensitivity optical signals while displaying an image was impossible.

An image display apparatus includes a display section where multiple display pixels are arrayed, a display signal writer that writes display signals on image pixels, multiple light sensing pixels arrayed in the display section for sensing light that is input, and an optical signal reader that reads the optical signal output from the light sensing pixels, and the image display apparatus has an optical signal summing unit that sums the optical signals output from the multiple light sensing pixels, and the optical signal reader has a function for reading out the optical signals summed by the optical signal summing unit.

This invention is capable of providing an image display apparatus capable reading out high-sensitivity, high-speed optical signals.

### BRIEF DESCRIPTION OF THE DRAWINGS

FIG. 1 is a circuit diagram of the liquid crystal display of the first embodiment;

FIG. 2 is a circuit diagram of the sensor gate line select circuit of the first embodiment;

FIG. 3 is a circuit diagram of the start and end address decoders of the first embodiment;

FIG. 4 is a circuit diagram of the sensor gate line drive circuit of the first embodiment;

FIG. 5 is a table showing the logic levels for the matching logic gate “X” of the first embodiment;

FIG. 6 is a drawing for describing a usage method for the first embodiment;

FIG. 7 is a timing chart for the gate lines and sensor gate lines of the first embodiment;

FIG. 8 is a cross sectional view of the photodiode and the sensing switch of the first embodiment;

FIG. 9 is a circuit diagram of the liquid crystal display of the second embodiment;

FIG. 10 is a circuit diagram of the liquid crystal display of the third embodiment;

FIG. 11 is a circuit diagram of the sensor gate line select circuit of the third embodiment;

FIG. 12 is a drawing for describing the usage method in the third embodiment;

FIG. 13 is a timing chart for the gate lines and sensor gate line block of the third embodiment;

FIG. 14 is a circuit diagram of the liquid crystal display of the fourth embodiment;

FIG. 15 is a cross sectional view of the light sensing TFT and the sensor switch of the fourth embodiment;

FIG. 16 is a circuit diagram of the liquid crystal display of the fifth embodiment;

FIG. 17 is a circuit diagram of the organic EL display of the sixth embodiment;

FIG. 18 is a drawing showing the structure of the TV/video image display device of the seventh embodiment; and

FIG. 19 is a circuit diagram of the liquid crystal display utilized in the related art.

### DETAILED DESCRIPTION OF THE EMBODIMENTS

The embodiments of the image display apparatus of this invention are described next while referring to the drawings.

### First Embodiment

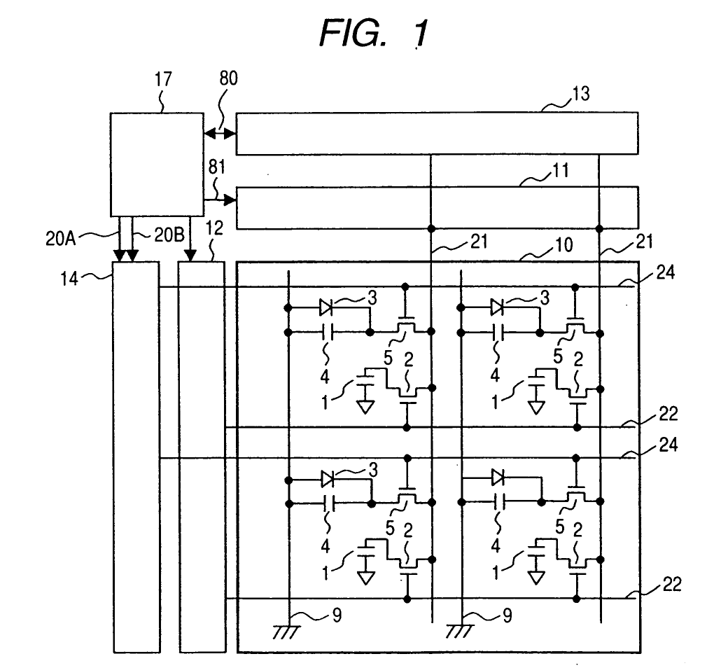

The structure and operation of the first embodiment of the image display apparatus of this invention is described next while referring to FIG. 1 through FIG. 8.

FIG. 1 is a circuit diagram of the liquid crystal display of the first embodiment of this invention. Each pixel in the display section 10 is composed of a pixel switch 2 and a liquid crystal capacitor 1. The pixel switch 2 gate is connected to a gate line scanning circuit 12 via a gate line 22. One end on the drain/source path of pixel switch 2 connects to a signal output circuit 11 via a signal line 21, and the other end connects to common lines via the capacitor 1.

Light sensing pixels made up of a sensor switch 5, a photodiode 3 and an electrical charge capacitor 4 are formed in the display section 10. One end of the photodiode 3 and electrical charge capacitor 4 connects to a ground 9. The gate of sensor switch 5 connects to a sensor gate line select circuit 14 via a sensor gate line 24. The other end of the photodiode 3 and electrical charge capacitor 4 connects to a sensing circuit 13 via source-drain path of the sensor switch 5 and a signal line 21.

A control circuit 17 controls a signal output circuit 11, a gate line scanning circuit 12, a sensing circuit 13, and a sensor gate line select circuit 14. The control circuit 17 here inputs signals to the sensor gate line select circuit 14 via a start address input line 20A and end address input line 20B. The control circuit 17 structure is composed of logic IC chip utilizing gate arrays. The bidirectional signal line 80 between the control circuit 17 and the sensing circuit 13 supplies control signals from the control circuit 17 for controlling the sensor circuit 13, and light sensing signals output from the sensing circuit 13 to the control circuit 17. A signal line 81 supplies control signals for controlling the signal output circuits.

The operation of the first embodiment is described next.

The gate line scanning circuit 12 turns on a specified pixel switch 2 selected via the gate line 22, and a display signal output from the signal output circuit 11 is then written on a specified pixel in the liquid crystal capacitor 1 via a selected pixel switch 2 and a signal line 21. An image from the display signal is displayed on the display section 10 made up of numerous pixels, by repeating this write operation on all pixels.

Inputting light onto the photodiode 3 generates an optical signal charges in the photodiode 3 proportional to the input light. These optical signal charges accumulate in the electrical charge capacitor 4 of each light sensing pixel. Here, when the control circuit 17 simultaneously turns on the consecutive multiple sensor gate lines 24 via the sensor gate line select circuit 14 at a specified timing, the optical signal charges accumulated in each of the selected light sensing pixels are all read out at once on the signal line 21, and the optical signal charges for each light sensing pixel connected along this same signal line 21 are summed on the signal line 21. The sensing circuit 13 reads out the optical signal charges summed on each signal line 21. The write optical signal pattern input to the display section 10 can in this way be detected.

The input end of the signal output circuit 11 is set to a high impedance when sensing the optical signal pattern. The input end of the sensing circuit 13 is set to a high impedance when the signal output circuit 11 is outputting a display signal on the signal line 21. A selector switch is utilized to control the impedance on the input ends of the signal output circuit 11 and the sensing circuit 13.

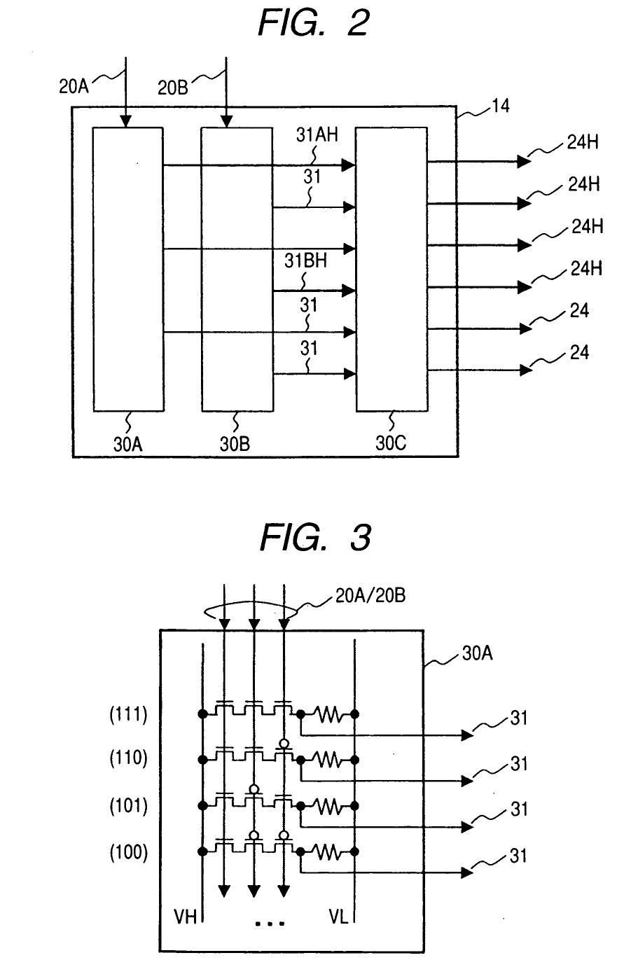

The sensor gate line select circuit 14 of the first embodiment is next described in further detail while referring to FIG. 2 through FIG. 5.

FIG. 2 is a circuit diagram of the sensor gate line select circuit 14 of the first embodiment.

The sensor gate line select circuit 14 contains a start address decoder 30A, an end address decoder 30B, and a sensor gate line drive circuit 30C. The control circuit 17 respectively inputs start address input line 20A (signals) and end address input line 20B (signals) to the start address decoder 30A and, the end address decoder 30B. The address lines 31 connects to the sensor gate line drive circuit 30C from the start address decoder 30A and end address decoder 30B. The sensor gate line drive circuit 30C connects to each address line 31 via a corresponding sensor gate line 24.

When the control circuit 17 inputs a select start address into the start address decoder 30A by way of the start address input line 20A, the start address decoder 30A inputs an address signal 31AH matching the select start address, into the sensor gate line drive circuit 30C.

When the control circuit 17 inputs a select end address into the end address decoder 30B by way of the end address input line 20B, the end address decoder 30B inputs an address signal 31BH matching the select end address, into the sensor gate line drive circuit 30C.

After receiving the address signal 31AH matching the select start address, and the address signal 31BH matching the select end address; the sensor gate line drive circuit 30C selects corresponding consecutive sensor gate lines 24H from the select start address to the select end address. Consecutive sensor gate lines 24 corresponding to the select start address and select end address output from the control circuit 17 are in this way selected, to select all light sensing pixels connected to that sensor gate line 24H.

FIG. 3 is a drawing showing the circuit structures of the above start address decoder 30A and the end address decoder 30B. The structures of the start address decoder 30A and the end address decoder 30B are identical so just the start address decoder 30A structure is shown here. The start address decoder 30A and the end address decoder 30B each contain a TFT (Thin-Film-Transistor) connected in serial to a resistor for each address line 31. The TFT are used here in a mixed n-type and p-type configuration.

A low voltage VL is input to one end of the resistors in the above structure, and a high voltage VH is input to one end of the TFT. The start address input line 20A or end address input line 20B (20A/20B) signals are input to each TFT gate as shown in FIG. 3. The start address input line 20A or end address input line 20B are an address bus for specifying a selected address.

The n-type TFT turns on when the address bus is at H (high) level, and the p-type TFT turns on when the address bus is at L (low) level so that an address line can be selected for the optional desired address, for the start address input line 20A or end address input line 20B by combining the n-type and p-type TFT as shown in the figure.

The start address input lines 20A or end address input lines 20B are here reduced to only 3 lines in order to simplify the drawing in FIG. 3. However there are actually nine respective address buses for the start address input lines 20A and end address input lines 20B for the 480 address lines 31. These nine address buses send addresses of up to 9 bits and can therefore control up to 512 addresses. The (111) through (100) shown in FIG. 3 are examples for showing the state when an address is input in the case where the address bus was reduced to 3 bits in order to simplify the drawing.

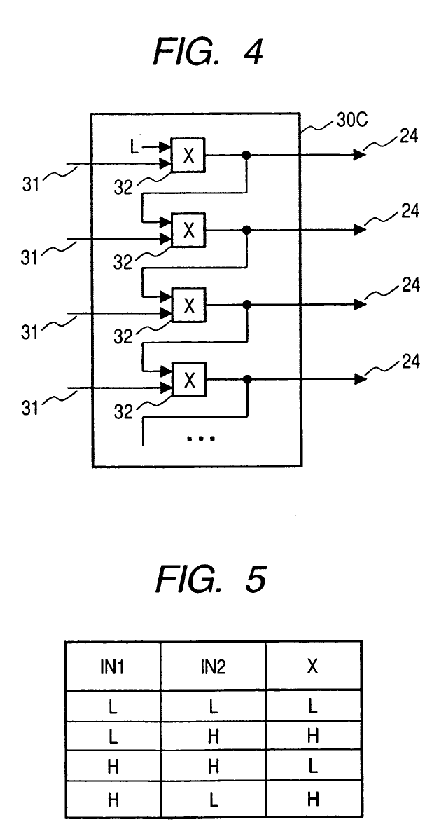

FIG. 4 is a circuit diagram of the sensor gate line drive circuit 30C. Address lines 31 signals are input in parallel to the sensor gate line drive circuit 30C. Corresponding logic gates “X” 32 are provided for those address lines 31. The output from each corresponding logic gate “X” 32 is simultaneously supplied to the sensor gate line 24 and input to the corresponding logic gate “X” 32 in the next stage. An L (low) level logic is input to the first corresponding logic gate “X” 32.

FIG. 5 illustrates the logic for these corresponding logic gates “X” 32. As clearly shown in FIG. 5, when the two inputs IN1, IN2 for the corresponding logic gate “X” 32 are both at a logic L (low) level or both at a logic H (high) level then an L (low) level is output. However, if these two inputs are L and H, (different logic levels) then the corresponding logic gate “X” 32 outputs an H level.

This type of logic structure allows the sensor gate line drive circuit 30C to keep the sensor gate line 24 at the H level serving as the ON state, from the time an address line 31 for an address changes to H level, to the time an address line 31 for another address changes to H level.

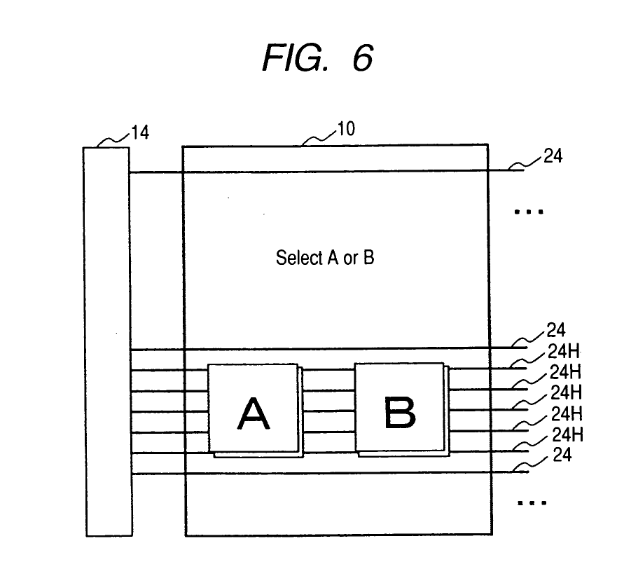

The method used for the liquid crystal display in the first embodiment is described next while referring to FIG. 6. Here, FIG. 6 is a diagram for describing the method for using the liquid crystal display of the first embodiment. FIG. 6 shows the state of switches named “A” and “B” along with the message “Select A or B” in a specified image on the liquid crystal display section 10. This message means that the user selects a switch “A” or “B” by touching it. The sensor circuit 13 reads out an optical signal charge output from a light sensing pixel caused by the user touching a switch “A” or “B” on the screen.

Here, the area where touch input by the user is valid is recorded as the switch states “A” and “B” so that the control circuit 17 selects and turns on multiple sensor gate lines 24H via the sensor gate line select circuit 14 in the area displayed for the switch states “A” and “B” from among the sensor gate lines 24. The optical signal charges accumulated in each of the light sensing pixels selected in this way are read out all at once on the corresponding signal line 21, and these optical signal charges on the light sensing pixels connected to this same signal line 21 are summed on the signal line 21. High sensitivity signal detection with a large signal-to-noise (SN) ratio can therefore be achieved by summing the optical signal charges.

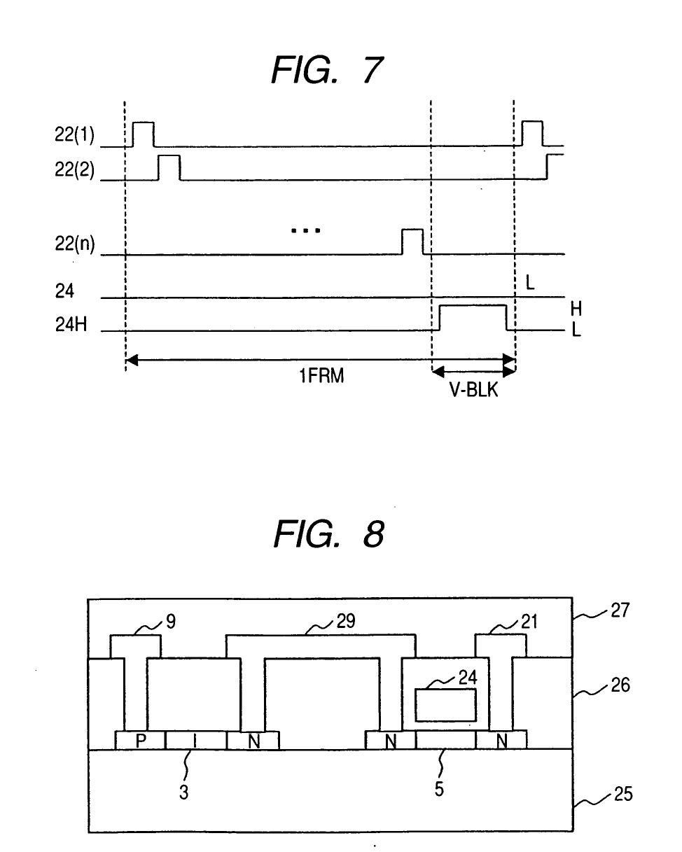

In the liquid crystal display of the first embodiment, the image must be simultaneously output when a change in the optical signal is detected by this type of finger touch input. The signal line 21 is also used for writing the display signal onto the signal line 21 as well as for summing and detecting the optical signal charges so both must be separated time-wise. That type of operation sequence is described next using FIG. 7.

FIG. 7 is a timing chart showing the gate lines 22 and sensor gate lines 24H that were selected and all turned on, and non-selected sensor gate lines 24. Numbers from (1) through (n) are assigned to the gate lines 22 from the first line to the nth line, and in this embodiment n=480.

The gate lines 22 are sequentially scanned from the first line to the nth line within 1 frame (1FRM) period. After writing the display signal in each pixel within the display section 10, the sensor gate lines 24H are turned on within the vertical blanking (V-BLK) period, and one set of optical signal charges are summed and readout. Non-selected sensor gate lines 24 are always off at this time.

The structures of the photodiode 3 and the sensor switch 5 are described next while referring to FIG. 8. FIG. 8 is a cross sectional view of the photodiode 3 and the sensor switch 5. The TFT channel layers functioning as the photodiode 3 and the sensor switch 5 are formed by doping the polycrystalline silicon thin film on the glass substrate 25 with P-type and N-type impurities. One end of the photodiode 3 is connected via a metallic wire to a ground 9, and other end is connected via a metal wire 29 within the light sensing pixel to one end of the sensor switch 5. The other end of the sensor switch 5 is connected to the signal line 21. The gate electrode of the sensor switch 5 forms the sensor gate line 24. Here, the I layer is a symbol showing that the impurity level is a low level (concentration) below the trap (energy) level density of the polycrystalline silicon thin film. An interlayer dielectric film 26 and a protective film 27 cover the photodiode 3 and the sensor switch 5.

In the first embodiment, the photodiode 3 and the sensor switch 5 were formed from polycrystalline silicon thin film as shown in FIG. 8. However this invention is not limited to polycrystalline silicon, and other organic/inorganic semiconductor thin films may be used in the transistors.

### Second Embodiment

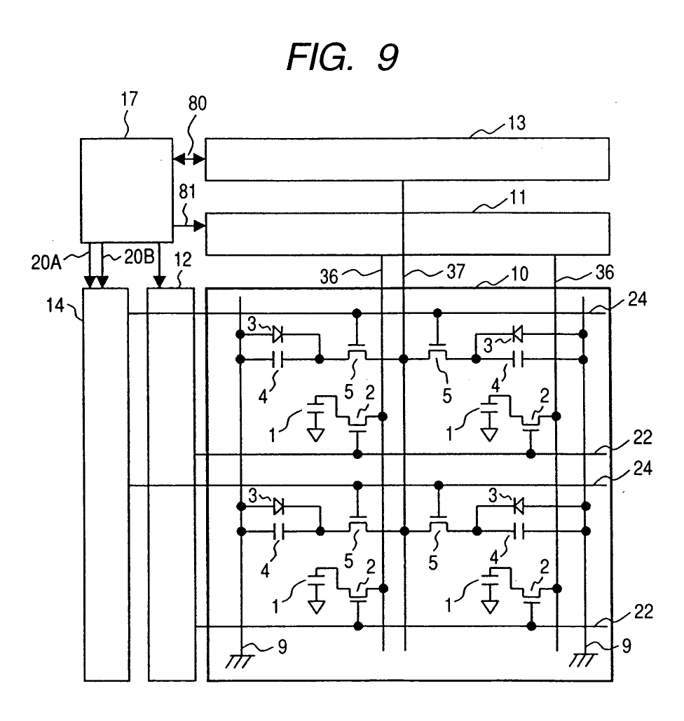

The second embodiment of this invention is described next while referring to FIG. 9. FIG. 9 is a circuit diagram of the liquid crystal display as the second embodiment of this invention. The structure and operation of the liquid crystal display of this embodiment are essentially the same as the first embodiment. The points differing from the first embodiment are that one end of the pixel switch 2 is connected to a signal output circuit 11 via a dedicated signal line 36, one end of the sensor switch 5 is connected to the sensing circuit 13 via a dedicated sensor line 37, and also that light sensing pixels are connected on the left and right of the dedicated sensor line 37, so that only that those changes are described next.

The operation of the second embodiment is essentially the same as the operation of the first embodiment. However the signal line 21 of the first embodiment is separated (in the second embodiment) into a dedicated signal line 36 and a dedicated sensor line 37 so that the optical signal charge can be read out via the dedicated sensor line 37 while writing display signals onto pixels via the dedicated signal line 36. Both (operations) can therefore operate at separate timings. Optical signal charges in the first embodiment could only be summed along the row direction but in the second embodiment the dedicated sensor line 37 is connected to light sensing pixels on the right and left, so that optical signal charges can be simultaneously summed in the line direction to therefore allow high-sensitivity signal detection with a larger signal-to-noise (S/N) ratio.

In the second embodiment, light sensing pixels were connected on the left and right of the dedicated sensor line 37. As an extension of this concept, a structure can be utilized where numerous light sensing pixels in the line direction are connected to one dedicated sensor line 37. In this case, high-sensitivity signal detection can be obtained with an even larger signal-to-noise (S/N) ratio.

Light sensing pixels were connected on the left and right of the dedicated sensor line 37 in the structure of the second embodiment. Needless to say however, light sensing pixels can also be connected on the left and right of the signal line 21 in the first embodiment.

### Third Embodiment

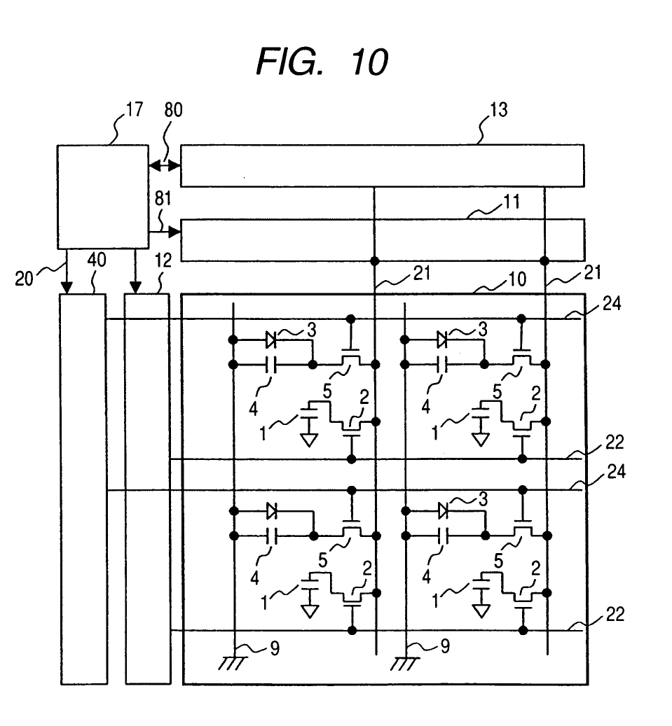

The third embodiment of this invention is described next while referring to FIG. 10 through FIG. 13. FIG. 10 is a circuit diagram of the liquid crystal display serving as the third embodiment of this invention.

The operation and structure of the liquid crystal display of this embodiment is essentially the same as the first embodiment. The point differing from the first embodiment is that a sensor gate line group select circuit 40 is used instead of the sensor gate lien select circuit 14. The sensor gate control line 20 connects from the control circuit 17 to the sensor gate line group select circuit 40. The operation of these components is described next.

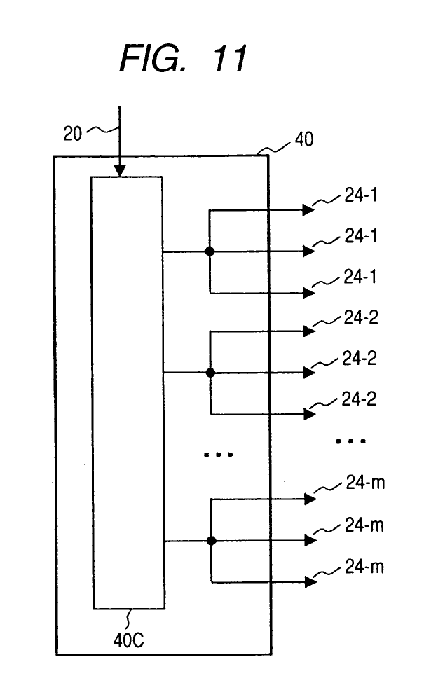

Operation of the sensor gate line group select circuit 40 in the third embodiment is described next in detail while referring to FIG. 11 through FIG. 13.

FIG. 11 is a circuit diagram of the sensor gate line group select circuit 40. This sensor gate line group select circuit 40 is composed of a sensor gate line group drive circuit 40C. Signals input to the sensor gate line group select circuit 40 from the control circuit 17 are input to the sensor gate line group drive circuit 40C. A sensor gate line 24 is connected to the sensor gate line group drive circuit 40C. This sensor gate line 24 is subdivided ahead of time into m number of blocks from 24-1 through 24-m, and each of these blocks are jointly connected within the sensor gate line group select circuit 40. In this example there are three m blocks.

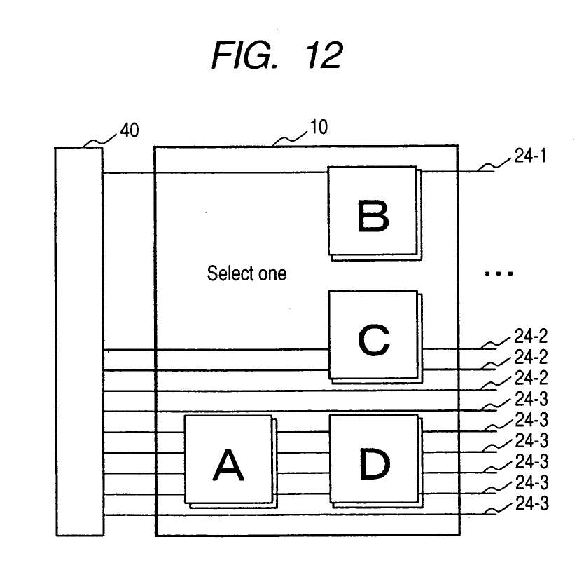

The method for using the liquid crystal display of the third embodiment is described next while referring to FIG. 12. FIG. 12 is a drawing for describing the usage method of the third embodiment. A specified image is displayed in the liquid crystal display section 10. Switch states labeled “A”, “B”, “C” and “D” are displayed along with the text “Select one”. This figure indicates a state awaiting selective input by the user touching the switches “A”, “B”, “C” or “D”. When the user has touched a switch displayed in the state “A”, “B”, “C” or “D” on the screen, an optical signal charge output from the light sensing pixel is then detected and read out by the sensing circuit 13. Areas here where touch input by the user is valid, are areas displayed by a switch state labeled “A”, “B”, “C” and “D”. The areas “A”, “B”, “C” and “D” here are displayed corresponding to the blocks 24-1, 24-2, 24-3 as shown in FIG. 12.

The control circuit 17 turns on the sensor gate lines 24 corresponding to the blocks 24-1, 24-2, 24-3 by way of the sensor gate line group select circuit 40. The sensor gate lines 24 within each block turn on all at once, so the optical signal charges accumulated in each selected light sensing pixel are in this way read out all at once on the corresponding signal line 21. The optical signal charges on the light sensing pixels connected to the same signal line 21 are summed on the signal line 21 so that high-sensitivity signal detection with a large signal-to-noise (S/N) ratio can be obtained on this embodiment.

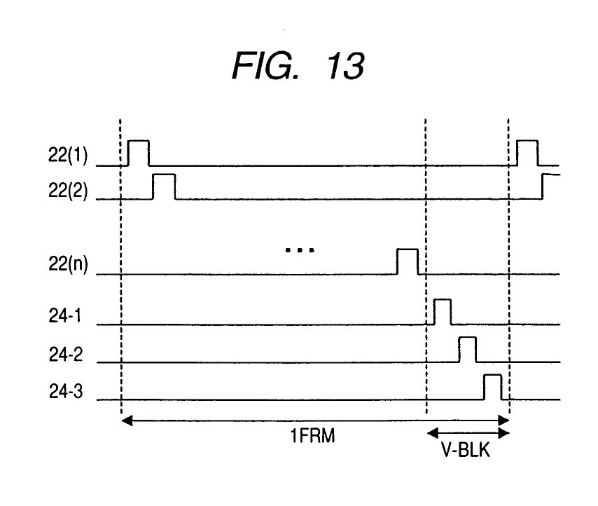

The operating sequence for the liquid crystal display of the third embodiment is described next while referring to FIG. 13. FIG. 13 is a timing chart for the selected sensor gate line blocks 24-1, 24-2, 24-3-turned on by each block and gate line 22. Numbers from (1) through (n) are assigned to the gate lines 22 from the first line to the nth line, and in this embodiment also, n=480.

The gate lines 22 are sequentially scanned from the first line to the nth line within 1 frame (1FRM) period. After writing the display signal in each pixel within the display section 10, the sensor gate lines 24 are turned on by each block 24-1, 24-2, 24-3 within the vertical blanking (V-BLK) period, and one group of optical signal charges are summed and readout.

In this example there were no non-selected sensor gate lines 24 but as can be clearly understood, in some cases, sensor gate line blocks 24-k that do not need to be selected may be permanently off.

### Fourth Embodiment

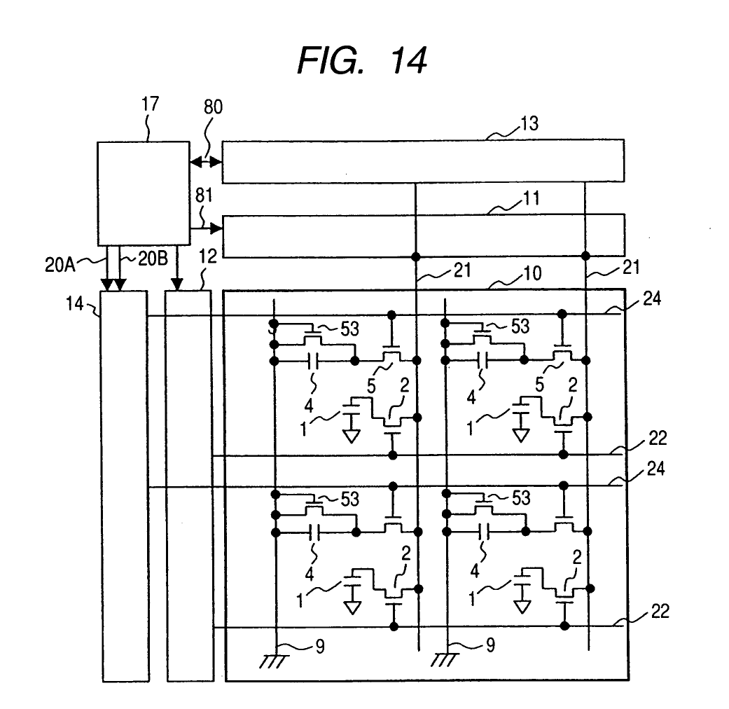

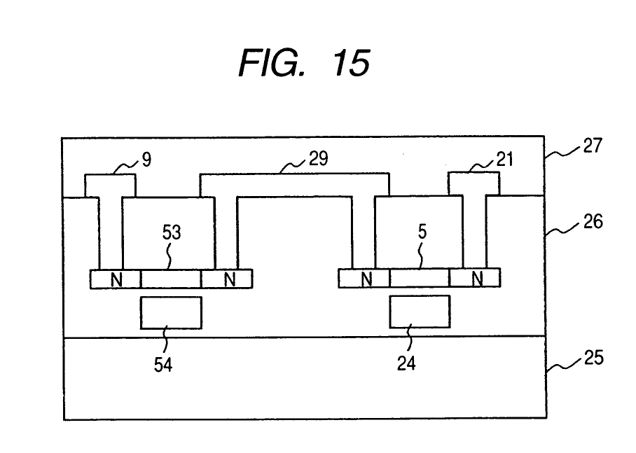

The fourth embodiment of this invention is described next while referring to FIG. 14 and FIG. 15. FIG. 14 is a circuit diagram of the liquid crystal display of the fourth embodiment. The structure and operation of this liquid crystal display is essentially the same as the first embodiment. The point differing from the first embodiment is that a light sensing TFT53 is used in the light sensing pixel instead of the photodiode 3. Therefore only that differing point is described here.

Except for substituting the photodiode 3 of the first embodiment with the light sensing TFT53, the operation of the fourth embodiment is identical to the first embodiment. The light sensing TFT53 is a diode connection where the gate is connected to the source, and the TFT threshold value is a positive voltage. Therefore, only a leakage current caused by dark current flows in a state where no light is irradiated, but inputting light the same as for the typical photodiode generates an optical signal current according to the amount of light absorption in the channel.

The structure of the light sensing TFT53 and the sensor switch 5 in this embodiment are described next while referring to FIG. 15. FIG. 15 is a cross sectional view of the structure of the light sensing TFT53 and the sensor switch 5. The gate electrode 54 of the light sensing TFT53 and the sensor gate line 24 of the sensor switch 5 are formed on the same layer structure on the glass substrate 25. A TFT channel layer for the light sensing TFT53 and the sensor switch 5 is formed by doping a polycrystalline silicon thin film with N-type impurities and enclosing a gate dielectric formed over the (electrode 54 and sensor gate line 24) layer structure. The light sensing TFT53 and sensor switch 5 are in a reverse staggered configuration. One end of the light sensing TFT53 is connected to the ground 9 via a metal wire, and the other end is connected to one end of the sensor switch 5 via a metal wire 29 within the light sensing pixel, the other end of the sensor switch 5 is connected to the signal line 21. The light sensing TFT53 and the sensor switch 5 are covered by an interlayer dielectric 26 and a protective film 27.

In this embodiment, the light sensing TFT53 and the sensor switch 5 were formed from a polycrystalline silicon thin film with a reverse stagger structure as shown in FIG. 15. However, other organic/inorganic semiconductor thin films may be used in the transistors regardless of the polycrystalline silicon. A coplanar structure as in the first embodiment may also be utilized.

The liquid crystal display of the present embodiment can be fabricated at a lower cost since-use of the light sensing TFT53 makes the P-type semiconductor layer unnecessary.

### Fifth Embodiment

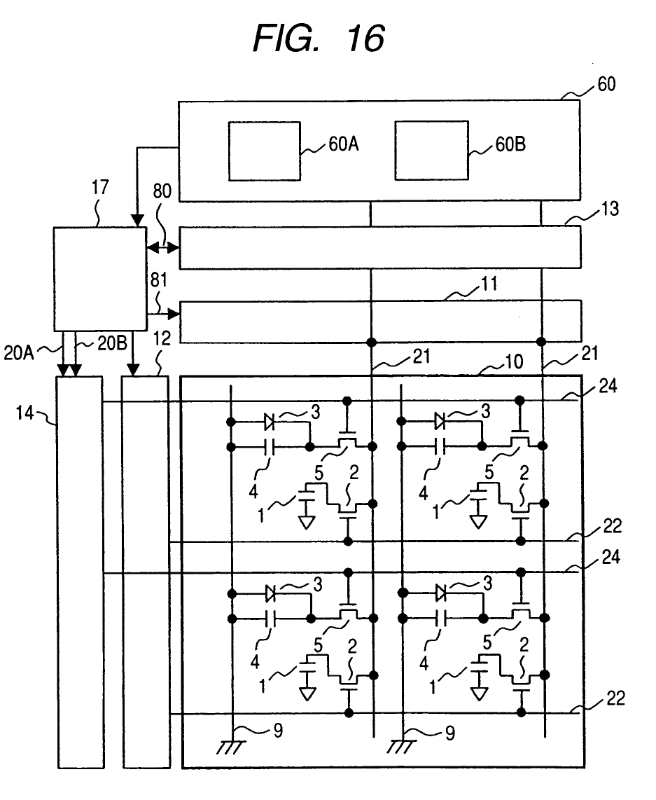

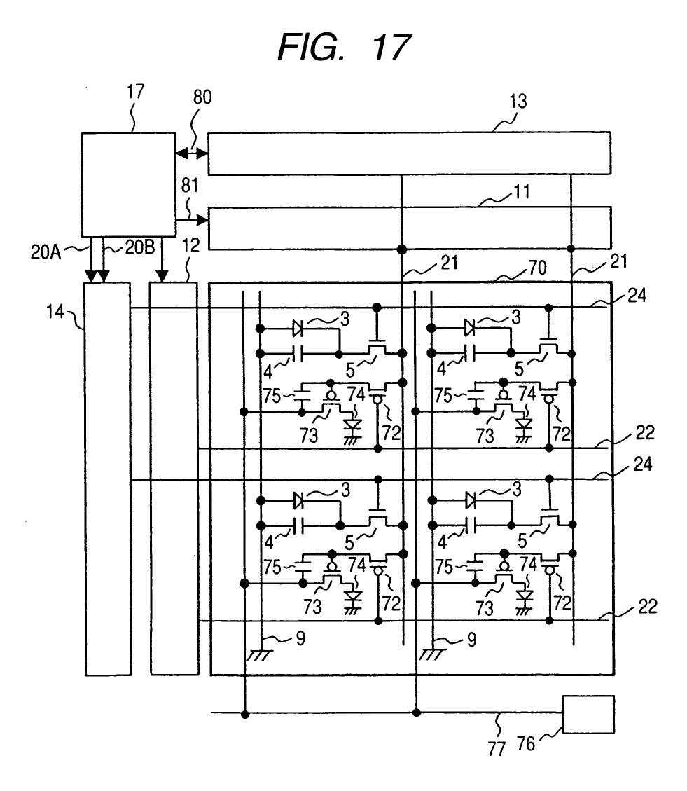

The fifth embodiment of this invention is described while referring to FIG. 16. FIG. 16 is a circuit diagram of the liquid crystal display of the fifth embodiment. The structure and operation of this liquid crystal display is essentially the same as the first embodiment. The point differing from the first embodiments that an optical signal differential circuit 60 containing an analog memory row 60A and an analog memory row 60B is formed in the output stage of the sensing circuit 13. Only that differing point is described here.

The sensing circuit 13 detecting the optical signal charge that was summed on the signal line 21, and outputs the optical signal voltage to an optical signal differential circuit 60. This optical signal differential circuit 60 writes the optical signal voltage that was input, into the analog memory row 60A storing it. At the next frame, the sensing circuit 13 again detects an optical signal charge that was summed on the signal line 21, and outputs an optical signal voltage to the optical signal differential circuit 60. However the optical signal differential circuit 60 this time writes the optical signal voltage that was input, into the analog memory row 60B storing it. The optical signal differential circuit 60 also outputs the differential between the optical signal voltage newly written in the analog memory row 60B, and the optical signal voltage pre-written into the analog memory row 60A, to the control circuit 17 via the signal line 80.

At the next frame, the sensing circuit 13 again detects an optical signal charge that was summed on the signal line 21, and outputs an optical signal voltage to the optical signal differential circuit 60. The optical signal differential circuit 60 writes this input optical signal voltage into the analog memory row 60A to store it, and repeats the sending of the differential versus the new optical signal voltage to the control circuit 17.

By finding the differential in the optical signal voltage between frames in this way, the fifth embodiment can remove error causes of all types that occur due to environmental light and temperature distributions, and can then read out just the changes occurring due to a finger touch on the display panel. So the fifth embodiment can in this way obtain a high-sensitivity signal readout with a large signal-to-noise (S/N) ratio.

### Sixth Embodiment

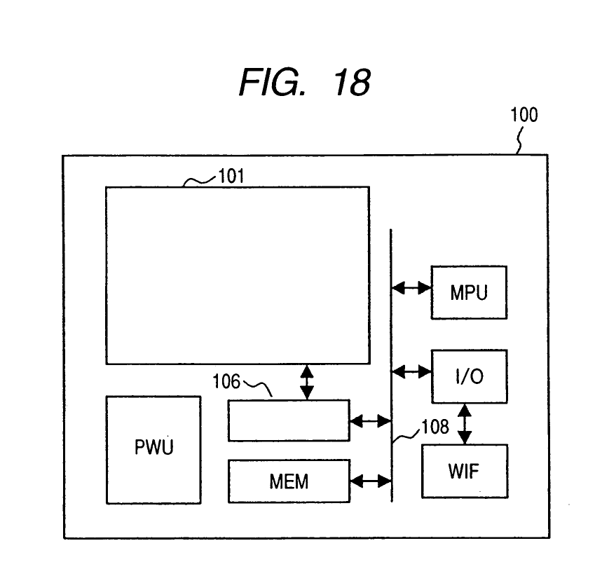

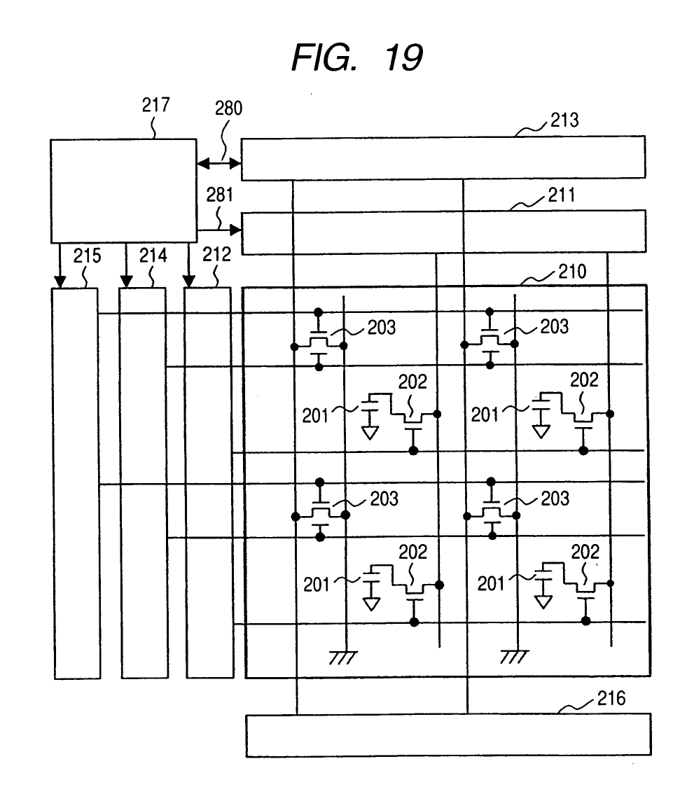

The sixth embodiment of this invention is described while referring to FIG. 17. FIG. 17 is a circuit diagram of the organic EL display of the sixth embodiment. Each pixel in the display section 70 contains a pixel switch 72 and storage capacitor 75, a drive TFT73, and an organic light emitting diode 74. The gate of the pixel switch 72 is connected to a gate line scanning circuit 12 via the gate line 22, and one end of the source/drain path of the pixel switch 72 connects to the signal output circuit 11 via the gate line 21. The other end of the pixel switch 72 connects to one end of the storage capacitor 75 and the gate of the drive TFT73. The drain terminal of the drive TFT73 is grounded by way of the organic light emitting diode 74. The source terminal on the drive TFT73 connects to the power supply 77 and the other end of the storage capacitor 75. The power supply 77 connects to the power supply circuit 76.

The light sensing pixel formed from a sensor switch 5, a photodiode 3 and a charge accumulating capacitor 4 is formed in the display section 70. One end of the photodiode 3 and the charge accumulating capacitor 4 is connected to the ground 9, the sensor switch 5 gate connects to the sensor line select circuit 14 via the sensor gate line 24, and the other end of the sensor switch 5 connects by way of the signal line 21 to the sensing circuit 13. The control circuit 17 controls the signal output circuit 11, the gate line scanning circuit 12, the sensing circuit 13, and the sensor gate line select circuit 14. The control circuit 17 in particular here inputs signals from the start address input line 20A and the end address input line 20B to the sensor line select circuit 14. The structure of this type of light sensing pixel section is the same as the first embodiment.

The operation of the sixth embodiment of this invention is described next. When the gate line scanning circuit 12 turns on a specific selected pixel switch 72 via the gate line 22, a display signal output from the signal output circuit 11 is written into the storage capacitor 75 of the specified pixel via a selected pixel switch 72 and the signal line 21. This process is repeated for all pixels. The display signal voltage written on the pixels is applied across the gate/source of the drive TFT73, so that the drive TFT73 inputs an organic EL drive current to the organic photodiode 74 corresponding to the display signal voltage, to emit light at the specified brightness. The organic EL display of this embodiment can in this way display a self-emitted light image from a display signal on a display section 70 made up of numerous pixels.

Inputting light onto the photodiode 3 generates an optical signal charge in the photodiode 3 according to the light that was input, and these optical signal charges accumulate in the charge accumulating capacitors 4 in each optical sensing pixel. When the control circuit 17 simultaneously turns on the multiple consecutive sensor gate lines 24 at a specified timing via the sensor gate line select circuit 14, the optical signal charges accumulated in each of the selected optical sensing pixels are readout all at once on the corresponding signal line 21, and the optical signal charges on light sensing pixels connected to that same signal line 21 are summed on the signal line 21.

The sensing circuit 13 reads out the optical signal charges summed on each of the signal lines 21. The write-optical signal patterns that were input to the display section 70 can be detected in this way. The input end on the signal output circuit 11 is set to a high impedance when detecting optical signal patterns, and the input end of the sensing circuit 13 is set to a high impedance when the signal output circuit 11 is outputting display signal to the signal line 21. A selector switch is utilized for controlling the impedance on the input end of the sensing circuit 13 and the signal output circuit 11. The operation of the light sensing pixels section is the same as the first embodiment of this invention.

The organic light emitting diodes 74 are a self-emitting light display so that the backlighting needed in the liquid crystal displays is unnecessary in this embodiment. The signal-to-noise (SN) deterioration in the optical signal caused by input of background light onto the light sensing pixels can therefore be avoided and high sensitivity signal detection with a larger signal-to-noise (SN) ratio can therefore be achieved.

The sixth embodiment is not limited to organic self-emitting diodes as light emitting devices and as readily apparent to those skilled in the art, may utilize ordinary light emitting devices such as inorganic EL devices and FED (Field Emission Devices). Moreover, a detailed description of the light emission layer was omitted since it is not an essential aspect of this embodiment, however molecular structures of all types such as macromolecular and low molecular structures may clearly also be utilized as the organic light emitting diode element structure.

In this embodiment, the opposing electrodes of the organic light-emitting photodiode 74 were grounded. However this voltage potential need not always be zero volts, and needless to say may be changed as needed including the polarity of the organic EL device.

### Seventh Embodiment

The seventh embodiment of this invention is described while referring to FIG. 18. FIG. 18 is a circuit diagram of the TV/video image display device 100 of the seventh embodiment. External data such as compressed image data is input as wireless data to the wireless interface circuit WIF that receives terrestrial (ground wave) digital signals. The output from the wireless interface circuit WIF is connected via an input/output circuit I/O to the data bus 108. Besides this wireless interface WIF, a microprocessor MPU, a display panel controller 106, and a frame memory MEM are connected to the data bus 108. The output from the display panel controller 106 input to the liquid crystal display 101. The video image display device 100 also contains a voltage generator circuit PWU. The liquid crystal display 101 utilizes the basic same structure and operation as the previously described first embodiment so that a description of the internal structure and operation is omitted here.

Moreover, when the microprocessor MPU sends a touch panel input command, the display panel controller 106 drives the liquid crystal display 101 light sensing circuit in compliance with that instruction, receives a light sensing output from the control circuit 17, and outputs the specified output data via the data bus 108 to the microprocessor MPU. The microprocessor MPU then performs a new operation in compliance with that output data.

This embodiment can therefore provide a TV/video image display device that is convenient to use and highly sensitive to inputs made via a touch panel.

The present embodiment utilized a liquid crystal display as the image display apparatus described in the first embodiment. However as is readily apparent to one skilled in the art, other types of structures not departing from the scope or spirit of the present invention may also be utilized.

What is claimed is:

1. An image display apparatus including:
a display section where a plurality of display pixels are arrayed;
a display signal writer that writes display signals on the image pixels and, a plurality of light sensing pixels arrayed in the display section that senses light input;
an optical signal reader that reads the optical signal output from the light sensing pixels,
the image display apparatus, comprising:
a light sensing pixel selector that selects a plurality of light sensing pixels; and
an optical signal summing unit that sums the optical signals output from the a plurality of light sensing pixels selected by the light sensing pixel selector,
wherein the optical signal reader has a function for reading out the optical signals summed by the optical signal summing unit.

2. The image display apparatus according to claim 1, wherein the display pixels are liquid crystal display pixels.

3. The image display apparatus according to claim 1, wherein the display pixels are electro-luminescence display pixels.

4. The image display apparatus according to claim 3, wherein the display pixels are organic electro-luminescence display pixels.

5. The image display apparatus according to claim 1, wherein the light sensing pixels are thin-film diodes.

6. The image display apparatus according to claim 1, wherein the light sensing pixels are thin-film transistors.

7. The image display apparatus according to claim 1, wherein the light sensing pixel selector utilizes an address decoder.

8. The image display apparatus according to claim 1, wherein the light sensing pixel selector utilizes a shift register.

9. The image display apparatus according to claim 1, wherein the optical signal summing unit utilizes an optical signal write wire as a section of the display signal writer.

10. The image display apparatus according to claim 1, wherein the optical signal summing unit utilizes an optical signal read out wire formed as a section of the optical signal read out means.

11. The image display apparatus according to claim 1, wherein the optical signal summing unit has a structure for summing the optical signals of the light sensing pixels in the vertical direction on the display section.

12. The image display apparatus according to claim 1, wherein the optical signal summing unit has a structure for summing the optical signals of the light sensing pixels in the horizontal scanning line direction on the display.

13. An image display apparatus including:
a display section where a plurality of display pixels are arrayed;
a data storage that stores display signal data;
a display signal generator that generates display signals utilizing the display signal data;
a display signal writer that writes display signals on the image pixels;
a plurality of light sensing pixels arrayed in the display section that senses light input; and
an optical signal reader that reads the optical signal output from the light sensing pixels,
the image display apparatus comprising:
a light sensing pixel selector that selects a plurality of light sensing pixels;
an optical signal summing unit that sums the optical signals output from the a plurality of light sensing pixels selected by the light sensing pixel selector, and
wherein the optical signal reader has a function for reading out the optical signals summed by the optical signal summing unit.
